(19) United States
(12) Patent Application Publication
(10) Pub. No.: US 2026/0160405 A1
(43) Pub. Date: Jun. 11, 2026

(54) ILLUMINATION DEVICE

(71) Applicant: Japan Display Inc., Tokyo (JP)

(72) Inventor: Shouhei ITOU, Tokyo (JP)

(21) Appl. No.: 19/278,374

(22) Filed: Jul. 23, 2025

Related U.S. Application Data
(63) Continuation of application No. PCT/JP2023/045907, filed on Dec. 21, 2023.

(30) Foreign Application Priority Data
Feb. 21, 2023 (JP) 2023-025289
Apr. 26, 2023 (JP) 2023-072553

(51) Int. Cl. F21V 14/00

(52) U.S. Cl. CPC F21V 14/003

(57) ABSTRACT

An illumination device includes a control device connected to an optical element including at least a first liquid crystal cell. The control device includes a first non-inverting circuit outputting a first potential, a first inverting circuit outputting a second potential having an opposite sign to the first potential, a first multiplexer connected to the first non-inverting circuit and the first inverting circuit and outputting a first pulse signal in which the first potential and the second potential are alternately repeated, and a first inverter connected to the first multiplexer and outputting a second pulse signal having an inverted phase of the first pulse signal. The first pulse signal is input to the first transparent electrode of the first liquid crystal. The second pulse signal is input to the second transparent electrode of the first liquid crystal cell.

### CROSS-REFERENCE TO RELATED APPLICATIONS

This application is a Continuation of International Patent Application No. PCT/JP2023/045907, filed on Dec. 21, 2023, which claims the benefit of priority to Japanese Patent Application No. 2023-025289, filed on Feb. 21, 2023, and Japanese Patent Application No. 2023-072553, filed on Apr. 26, 2023, the entire contents of which are incorporated herein by reference.

### FIELD

An embodiment of the present invention relates to an illumination device using a liquid crystal to control a distribution of light emitted from a light source.

### BACKGROUND

An optical element which is a so-called liquid crystal lens has been conventionally known in which a change in the refractive index of a liquid crystal is utilized by adjusting a voltage applied to the liquid crystal. Further, an illumination device including a light source and a liquid crystal lens has been developed (for example, see Japanese laid-open patent publication No. 2021-117344).

### SUMMARY

An illumination device according to an embodiment of the present invention includes a light source, an optical element including a first liquid crystal cell and a second liquid crystal cell and transmitting light emitted from the light source in a diffusible manner, and a control device connected to the optical element and controlling the optical element. Each of the first liquid crystal cell and the second liquid crystal cell includes a first substrate on which a first transparent electrode and a second transparent electrode are arranged each extending in a first direction, a second substrate on which a third transparent electrode and a fourth transparent electrode are arranged each extending in a second direction orthogonal to the first direction, and a liquid crystal layer between the first substrate and the second substrate. The control device includes a first non-inverting circuit outputting a first potential, a first inverting circuit outputting a second potential having an opposite sign to the first potential, a first multiplexer connected to the first non-inverting circuit and the first inverting circuit and outputting a first pulse signal in which the first potential and the second potential are alternately repeated, and a first inverter connected to the first multiplexer and outputting a second pulse signal having an inverted phase of the first pulse signal. The first pulse signal is input to the first transparent electrode of the first liquid crystal. The second pulse signal is input to the second transparent electrode of the first liquid crystal cell.

An illumination device according to an embodiment of the present invention includes a light source, an optical element including a first liquid crystal cell and a second liquid crystal cell and transmitting light emitted from the light source in a diffusible manner, and a control device connected to the optical element, and controlling the optical element. Each of the first liquid crystal cell and the second liquid crystal cell includes a first substrate on which a first transparent electrode and a second transparent electrode are arranged each extending in a first direction, a second substrate on which a third transparent electrode and a fourth transparent electrode are arranged each extending in a second direction orthogonal to the first direction, and a liquid crystal layer between the first substrate and the second substrate. The control device includes a first non-inverting circuit outputting a first potential, a first inverting circuit outputting a second potential having an opposite sign to the first potential, a first multiplexer connected to the first non-inverting circuit and the first inverting circuit and outputting a first pulse signal in which the first potential and the second potential are alternately repeated, and a first adding circuit connected to the first multiplexer and outputting a second pulse signal in which a predetermined potential is added to a potential of the first pulse signal, and a first inverter connected to the first adding circuit and outputting a third pulse signal having an inverted phase of the second pulse signal. The second pulse signal is input to the first transparent electrode of the first liquid crystal. The third pulse signal is input to the second transparent electrode of the first liquid crystal cell.

### BRIEF DESCRIPTION OF DRAWINGS

FIG. 1 is a schematic diagram showing a configuration of an illumination device according to an embodiment of the present invention.

FIG. 2A is a schematic cross-sectional view showing a configuration of an optical element of an illumination device according to an embodiment of the present invention.

FIG. 2B is a schematic cross-sectional view showing a configuration of an optical element of an illumination device according to an embodiment of the present invention.

FIG. 3A is a schematic plan view showing an electrode pattern of a liquid crystal cell included in an optical element of an illumination device according to an embodiment of the present invention.

FIG. 3B is a schematic plan view showing an electrode pattern of a liquid crystal cell included in an optical element of an illumination device according to an embodiment of the present invention.

FIG. 4A is a schematic diagram illustrating optical characteristics of a liquid crystal cell included in an optical element of an illumination device according to an embodiment of the present invention.

FIG. 4B is a schematic diagram illustrating optical characteristics of a liquid crystal cell included in the optical element of an illumination device according to an embodiment of the present invention.

FIG. 5 is a block diagram showing a configuration of an illumination device according to an embodiment of the present invention.

FIG. 6 is a circuit diagram showing a circuit configuration of a control circuit of an illumination device according to an embodiment of the present invention.

FIG. 7 is a circuit diagram showing a circuit configuration of a control circuit of an illumination device according to an embodiment of the present invention.

FIG. 8 is a block diagram showing a configuration of an illumination device according to an embodiment of the present invention.

FIG. 9 is a block diagram showing a configuration for generating a pulse wave and a fixed potential in an illumination device according to an embodiment of the present invention.

### DESCRIPTION OF EMBODIMENTS

An optical element of an illumination device includes a control circuit and a microcomputer for controlling a light distribution, and the control circuit includes a digital-to-analog converter circuit (DAC) and an amplifier circuit (AMP) that occupy a large area. In a conventional optical element, a voltage signal is generated for each transparent electrode that applies a voltage to a liquid crystal, and the number of DACs and AMPs increases when the optical element has a large number of transparent electrodes. However, when the number of DACs and AMPs that occupy a large area increases, the control circuit becomes larger and the manufacturing cost increases. Further, the microcomputer also increases the manufacturing cost of the illumination device. Therefore, it has been desired to reduce the manufacturing cost of the illumination device.

In view of the above problems, an embodiment of the present invention can provide an illumination device, which can be manufactured at reduced costs.

In the following description, each of the embodiments of the present invention is described with reference to the drawings. However, the present invention can be implemented in various modes without departing from the gist of the invention and should not be interpreted as being limited to the description of the embodiments exemplified below.

Although the drawings may be schematically represented in terms of width, thickness, shape, and the like of each part as compared with their actual mode in order to make explanation clearer, they are only an example and an interpretation of the present invention is not limited. In addition, in the drawings, the same reference numerals are provided to the same elements as those described previously with reference to preceding figures and repeated explanations may be omitted accordingly.

In the case when a single film is processed to form a plurality of structural bodies, each structural body may have different functions and roles, and the bases formed beneath each structural body may also be different. However, the plurality of structural bodies is derived from films formed in the same layer by the same process and have the same material. Therefore, the plurality of these films is defined as existing in the same layer.

When expressing a mode in which another structure is arranged over a certain structure, in the case where it is simply described as “over”, unless otherwise noted, a case where another structure is arranged directly over a certain structure as if in contact with that structure, and a case where another structure is arranged via yet another structure over a certain structure, are both included.

### First Embodiment

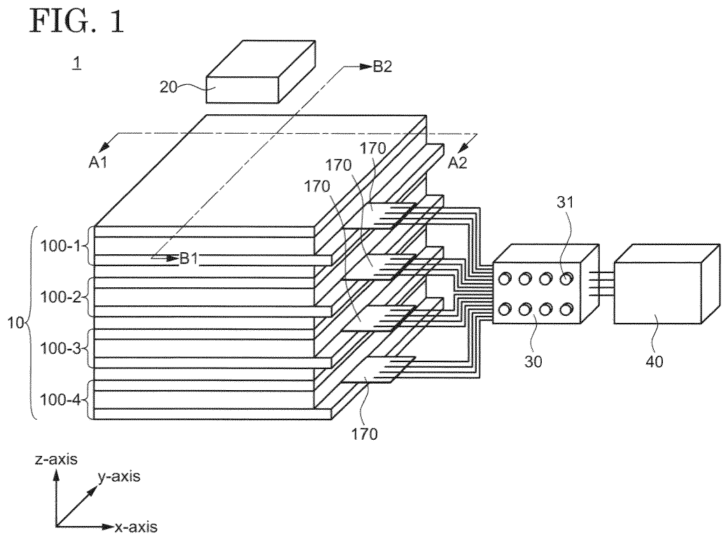

An illumination device 1 according to an embodiment of the present invention is described with reference to FIGS. 1 to 7.

### 1. Configuration of Illumination Device 1

FIG. 1 is a schematic diagram showing a configuration of the illumination device 1 according to an embodiment of the present invention. As shown in FIG. 1, the illumination device 1 includes an optical element 10, a light source 20, a control device 30, and a power supply device 40.

The optical element 10 includes four liquid crystal cells 100 (a first liquid crystal cell 100-1, a second liquid crystal cell 100-2, a third liquid crystal cell 100-3, and a fourth liquid crystal cell 100-4). In the optical element 10, the first liquid crystal cell 100-1, the second liquid crystal cell 100-2, the third liquid crystal cell 100-3, and the fourth liquid crystal cell 100-4 are stacked in the z-axis direction in order from the side closer to the light source 20. In addition, although a configuration in which the optical element 10 includes four liquid crystal cells 100 is described below, the number of liquid crystal cells 100 included in the optical element 10 is not limited to four. It is sufficient that the optical element 10 includes at least two liquid crystal cells 100. The details of the configuration of the optical element 10 are described later.

The light source 20 can emit light to the optical element 10. The light emitted from the light source 20 is incident on the first liquid crystal cell 100-1 and is irradiated from the fourth liquid crystal cell 100-4. In the illumination device 1, the diffusion and polarization of light are controlled by the four liquid crystal cells 100 included in the optical element 10, and the light distribution of the light irradiated from the fourth liquid crystal cell 100-4 can be changed. That is, the optical element 10 can transmit the light emitted from the light source 20 in a diffusible manner and control the light distribution. For example, light emitting diodes (LEDs) can be used for the light source 20. However, the light source 20 is not limited thereto. The light source 20 may be any element or device that can emit light.

The control device 30 is connected to the optical element 10 and can control the optical element 10. The control device 30 is provided with eight volume knobs 31 that can be rotated by a user. By changing the combination of the rotations of the eight volume knobs 31 and the rotation angles of each of the eight volume knobs 31, the volume knobs 31 can adjust the shape or distribution of the light emitted from the optical element 10. In other words, the liquid crystal cell 100 can be controlled by the volume knobs 31. Two volume knobs 31 are assigned to control one liquid crystal cell 100. The volume knobs 31 may be of a sliding type instead of a rotating type. The details of the configuration of the control device 30 are described later.

The power supply device 40 is connected to the control device 30 and can supply power to the control device 30. That is, the power supply device 40 can generate a predetermined voltage. Further, although it is possible that the power supply device 40 generates two voltages (e.g., −7.5 V and +7.5 V), voltages generated by the power supply 40 are not limited thereto. The voltages generated by the power supply device 40 may include GND (e.g., 0 V). In addition, for convenience, even in the case of GND, it may be described that a voltage is generated in the present specification.

In addition, although FIG. 1 shows the control device 30 and the power supply device 40 as separate devices, the illumination device 1 may have a configuration in which the control device 30 and the power supply device 40 are integrated together.

### 2. Configuration of Optical Element 10

### [2-1. Structure of Optical Element 10]

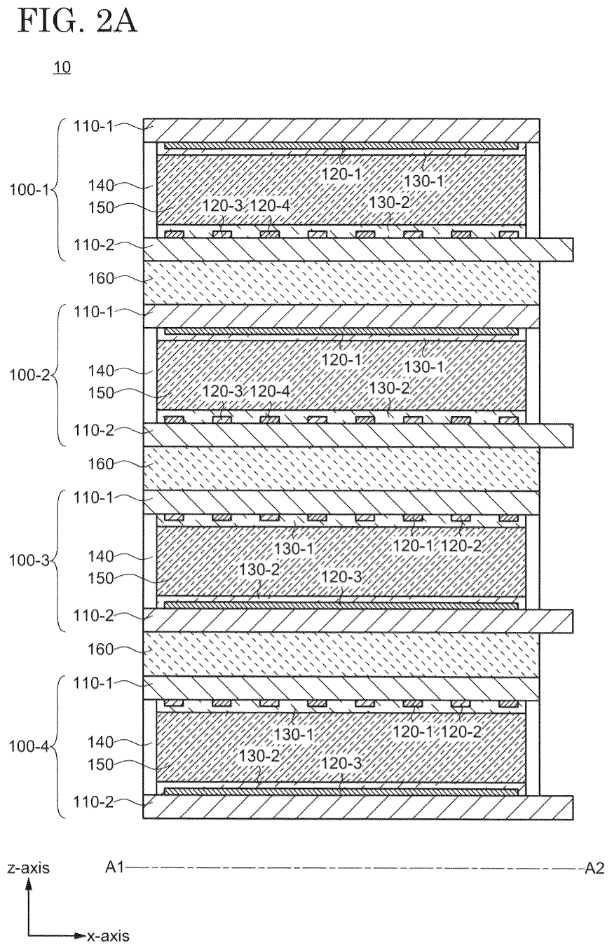

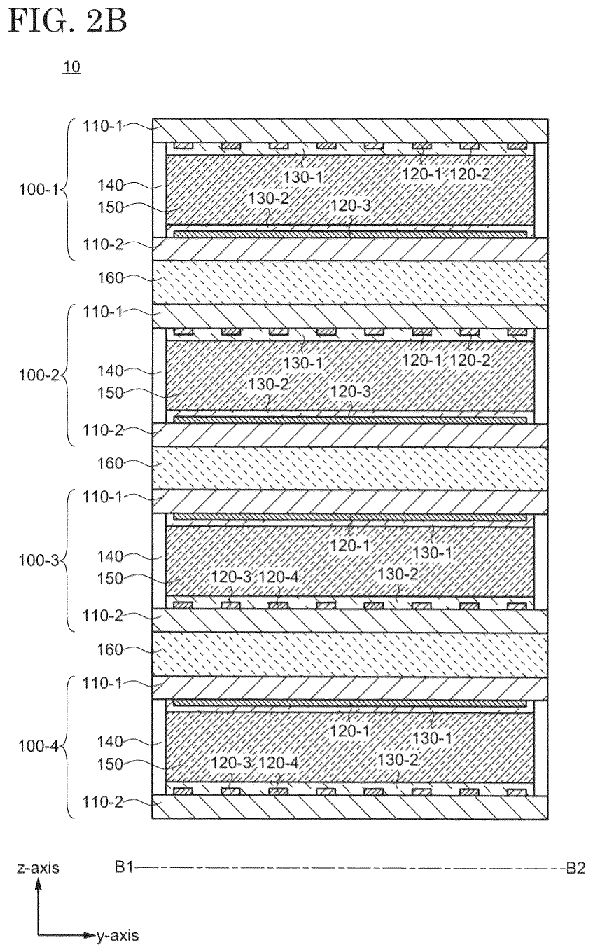

Each of FIGS. 2A and 2B is a schematic cross-sectional view showing a configuration of the optical element 10 of the illumination device 1 according to an embodiment of the present invention. Specifically, FIG. 2A is a cross-sectional view of the optical element 10 taken along the line A1-A2 in FIG. 1, and FIG. 2B is a cross-sectional view of the optical element 10 taken along the line B1-B2 in FIG. 1.

As shown in FIGS. 2A and 2B, each of the first liquid crystal cell 100-1 to the fourth liquid crystal cell 100-4 includes a first substrate 110-1, a second substrate 110-2, a plurality of first transparent electrodes 120-1, a plurality of second transparent electrodes 120-2, a plurality of third transparent electrodes 120-3, a plurality of fourth transparent electrodes 120-4, a first alignment film 130-1, a second alignment film 130-2, a sealant 140, and a liquid crystal layer 150. The first transparent electrodes 120-1 and the second transparent electrodes 120-2 are alternately provided on the first substrate 110-1. Further, the first alignment film 130-1 is provided on the first substrate 110-1 so as to cover the first transparent electrodes 120-1 and the second transparent electrodes 120-2. The third transparent electrodes 120-3 and the fourth transparent electrode 120-4 are alternately provided on the second substrate 110-2. Further, the second alignment film 130-2 is provided on the second substrate 110-2 so as to cover the third transparent electrodes 120-3 and the fourth transparent electrodes 120-4. The first substrate 110-1 and the second substrate 110-2 are disposed so that the first transparent electrodes 120-1 and the second transparent electrodes 120-2 face the third transparent electrodes 120-3 and the fourth transparent electrodes 120-4, and are bonded via a sealing member 140 provided on the periphery of the first substrate 110-1 and the second substrate 110-2. A liquid crystal is sealed in a space surrounded by the first substrate 110-1 (more specifically, the first alignment film 130-1), the second substrate 110-2 (more specifically, the second alignment film 130-2), and the sealing member 140, and the liquid crystal layer 150 is provided between the first substrate 110-1 and the second substrate 110-2.

An optical elastic resin layer 160 is provided between the first liquid crystal cell 100-1 and the second liquid crystal cell 100-2. Similarly, optical elastic resin layers 160 are provided between the second liquid crystal cell 100-2 and the third liquid crystal cell 100-3, and between the third liquid crystal cell 100-3 and the fourth liquid crystal cell 100-4. For example, an adhesive containing a light-transmitting acrylic resin can be used for the optical elastic resin layer 160. That is, the optical elastic resin layer 160 can bond and fix two adjacent liquid crystal cells 100 together.

For example, a rigid substrate having light-transmitting properties such as a glass substrate, a quartz substrate, or a sapphire substrate is used as each of the first substrate 110-1 and the second substrate 110-2. Further, a flexible substrate having light-transmitting properties such as a polyimide resin substrate, an acrylic resin substrate, a siloxane resin substrate, or a fluorine resin substrate can also be used as each of the first substrate 110-1 and the second substrate 110-2.

Each of the first transparent electrode 120-1, the second transparent electrode 120-2, the third transparent electrode 120-3, and the fourth transparent electrode 120-4 functions as an electrode for forming an electric field in the liquid crystal layer 150. For example, a transparent conductive material such as indium tin oxide (ITO) or indium zinc oxide (IZO) is used for each of the first transparent electrode 120-1, the second transparent electrode 120-2, the third transparent electrode 120-3, and the fourth transparent electrode 120-4.

In the first liquid crystal cell 100-1 and the second liquid crystal cell 100-2, the first transparent electrode 120-1 and the second transparent electrode 120-2 extend in the x-axis direction, and the third transparent electrode 120-3 and the fourth transparent electrode 120-4 extend in the y-axis direction. In the third liquid crystal cell 100-3 and the fourth liquid crystal cell 100-4, the first transparent electrode 120-1 and the second transparent electrode 120-2 extend in the y-axis direction, and the third transparent electrode 120-3 and the fourth transparent electrode 120-4 extend in the x-axis direction.

In addition, when the first transparent electrode 120-1 to the fourth transparent electrode 120-4 are not particularly distinguished from each other, they may be referred as a transparent electrode 120 in the following description.

Each of the first alignment film 130-1 and the second alignment film 130-2 aligns the liquid crystal molecules in the liquid crystal layer 150 in a predetermined direction. For example, a polyimide resin or the like can be used for each of the first alignment film 130-1 and the second alignment film 130-2. In addition, each of the first alignment film 130-1 and the second alignment film 130-2 may be imparted with alignment properties by an alignment treatment such as a rubbing method or a photo-alignment method. The rubbing method is a method of rubbing the surface of the alignment film in one direction. The photo-alignment method is a method of irradiating an alignment film with linearly polarized ultraviolet rays.

An alignment treatment is performed on the first alignment film 130-1 so that the liquid crystal molecules on the first substrate 110-1 side of the liquid crystal layer 150 are aligned in a direction perpendicular to the extending direction of the first transparent electrode 120-1 and the second transparent electrode 120-2. An alignment treatment is performed on the second alignment film 130-2 so that the liquid crystal molecules on the second substrate 110-2 side of the liquid crystal layer 150 are aligned in a direction perpendicular to the extending direction of the third transparent electrode 120-3 and the fourth transparent electrode 120-4. Therefore, in the first liquid crystal cell 100-1 and the second liquid crystal cell 100-2, the long axes of the liquid crystal molecules on the side of the first substrate 110-1 are aligned in the y-axis direction, and the long axes of the liquid crystal molecules on the side of the second substrate 110-2 are aligned in the x-axis direction. Further, in the third liquid crystal cell 100-3 and the fourth liquid crystal cell 100-4, the long axes of the liquid crystal molecules on the side of the first substrate 110-1 are aligned in the x-axis direction, and the long axes of the liquid crystal molecules on the side of the second substrate 110-2 are aligned in the y-axis direction.

An adhesive material containing epoxy resin or acrylic resin is used for the sealing member 140. The adhesive material may be an ultraviolet curing type or a heat curing type.

The liquid crystal layer 150 can refract transmitted light or change the polarization state of transmitted light in accordance with the alignment state of the liquid crystal molecules. For example, nematic liquid crystal can be used as the liquid crystal of the liquid crystal layer 150. Although a positive liquid crystal is described as the liquid crystal in the present embodiment, a negative liquid crystal can also be adopted by changing the initial alignment directions of the liquid crystal molecules. Further, the liquid crystal preferably contains a chiral agent that imparts twist to the liquid crystal molecules.

### [2-2. Electrode Pattern of Liquid Crystal Cell 100]

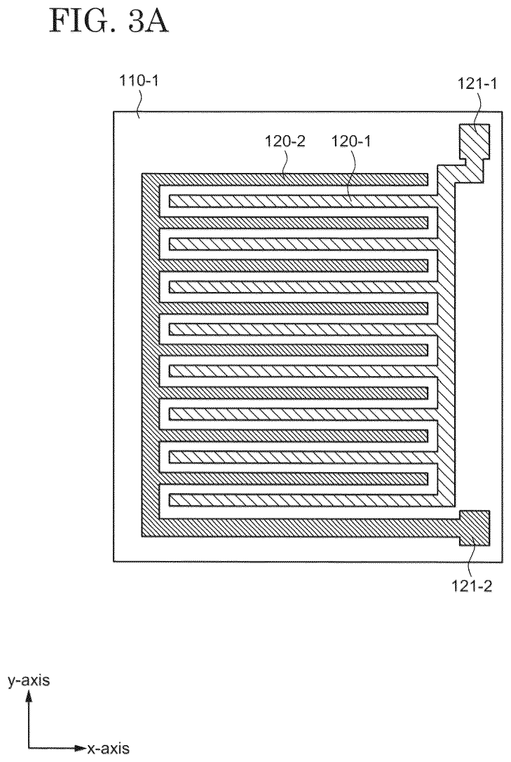

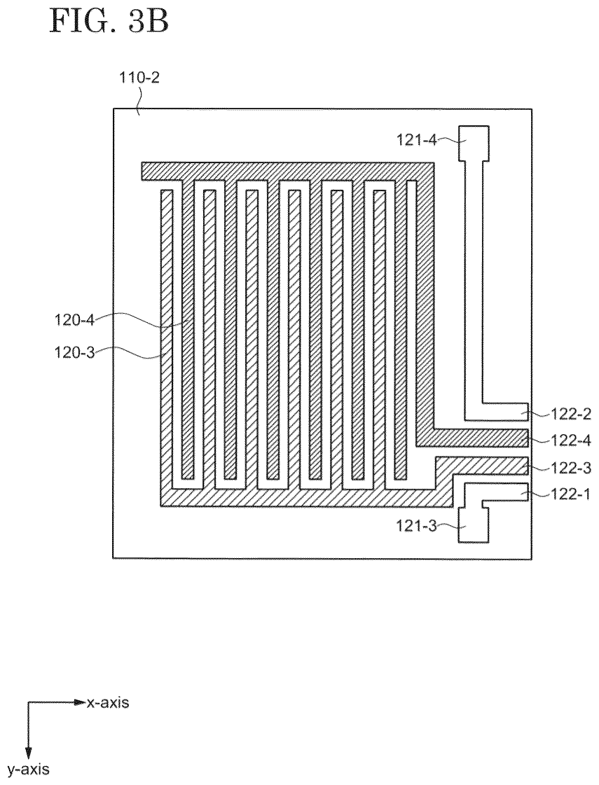

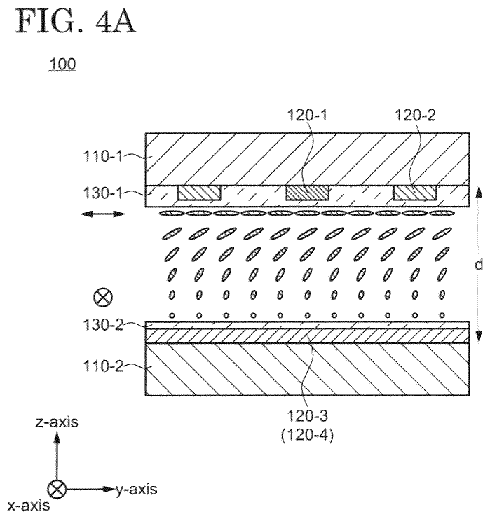

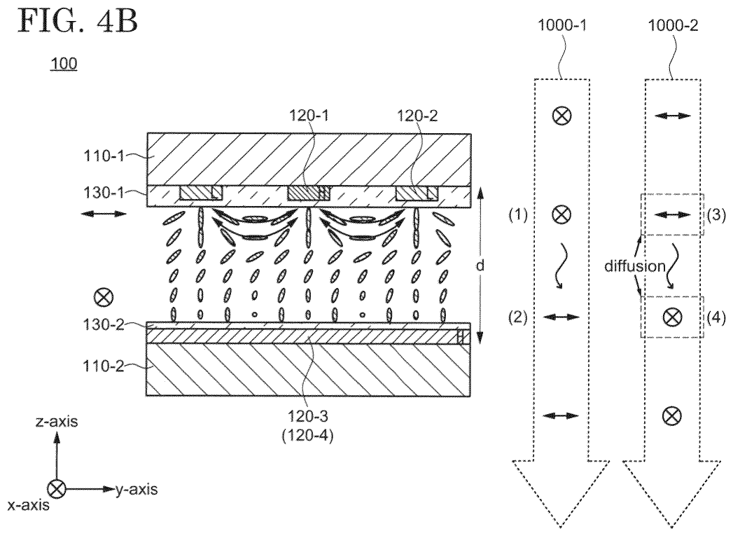

Each of FIGS. 4A and 4B is a schematic plan view showing an electrode pattern of the liquid crystal cell 100 included in the optical element 10 of the illumination device 1 according to an embodiment of the present invention. Specifically, FIG. 4A is a plan view showing an electrode pattern formed on the first substrate 110-1 of the first liquid crystal cell 100-1, and FIG. 4B is a plan view showing an electrode pattern formed on the second substrate 110-2 of the first liquid crystal cell 100-1. In addition, in FIG. 3A, in order to prioritize ease of understanding, a state viewed from the +z direction is shown as in FIG. 3B, and a transparent electrode 120 to be provided through the substrate is shown by a solid line.

As shown in FIG. 3A, a first connection pad 121-1 and a second connection pad 121-2 are provided on the first substrate 110-1. The plurality of first transparent electrodes 120-1 are electrically connected to the first connection pad 121-1. The plurality of second transparent electrodes 120-2 are electrically connected to the second connection pad 121-2.

As shown in FIG. 3B, a third connection pad 121-3, a fourth connection pad 121-4, a first terminal 122-1, a second terminal 122-2, a third terminal 122-3, and a fourth terminal 122-4 are provided on the second substrate 110-2. The third transparent electrodes 120-3 are electrically connected to the third terminal 122-3. The fourth transparent electrodes 120-4 are electrically connected to the fourth terminal 122-4. The third connection pad 121-3 is electrically connected to the first terminal 122-1. The fourth connection pad 121-4 is electrically connected to the second terminal 122-2.

When the first substrate 110-1 and the second substrate 110-2 are bonded to each other, the first connection pad 121-1 and the second connection pad 121-2 overlap the third connection pad 121-3 and the fourth connection pad 121-4, respectively. Since a conductive electrode is provided between the first connection pad 121-1 and the third connection pad 121-3, the first connection pad 121-1 and the third connection pad 121-3 are electrically connected via the conductive electrode. Similarly, since a conductive electrode is provided between the second connection pad 121-2 and the fourth connection pad 121-4, the second connection pad 121-2 and the fourth connection pad 121-4 are electrically connected via the conductive electrode. Therefore, the first transparent electrode 120-1 and the second transparent electrode 120-2 on the first substrate 110-1 are electrically connected to the first terminal 122-1 and the second terminal 122-2, respectively.

The electrode pattern of the second liquid crystal cell 100-2 is the same as that of the first liquid crystal cell 100-1. The configurations of the electrode patterns of the third liquid crystal cell 100-3 and the fourth liquid crystal cell 100-4 are similar to that of the first liquid crystal cell 100-1, except that the extending direction of the transparent electrode 120 differs by 90 degrees.

In the liquid crystal cell 100, the first terminal 122-1 to the fourth terminal 122-4 on the second substrate 110-2 are exposed from the first substrate 110-1. In each of the first liquid crystal cell 100-1 to the fourth liquid crystal cell 100-4, the exposed first terminal 122-1 to the fourth terminal 122-4 are electrically connected to the control device 30 via the FPCs 170 (see FIG. 1). The control device 30 inputs predetermined pulse signals to the first terminal 122-1 to the fourth terminal 122-4 of each of the first liquid crystal cell 100-1 to the fourth liquid crystal cell 100-4, and a predetermined potential is applied to each of the first transparent electrode 120-1 to the fourth transparent electrode 120-4 of each of the first liquid crystal cell 100-1 to the fourth liquid crystal cell 100-4. In this way, since the alignment state of the liquid crystal molecules in the liquid crystal layer 150 of each of the first liquid crystal cell 100-1 to the fourth liquid crystal cell 100-4 is changed, it is possible to change the distribution of light passing through the optical element 10.

### [2-3. Optical Characteristics of Liquid Crystal Cell 100]

Each of FIGS. 4A and 4B is a schematic diagram illustrating optical characteristics of the liquid crystal cell 100 included in the optical element 10 of the illumination device 1 according to an embodiment of the present invention. Specifically, FIG. 4A shows the liquid crystal cell 100 in a state where no voltage is applied to the transparent electrodes 120, and FIG. 4B shows the liquid crystal cell 100 in a state where voltages are applied to the transparent electrodes 120.

As shown in FIG. 4A, the liquid crystal molecules on the first substrate 110-1 side of the liquid crystal layer 150 are aligned in the y-axis direction, and the liquid crystal molecules on the second substrate 110-2 side of the liquid crystal layer 150 are aligned in the x-axis direction. Therefore, when no voltage is applied to any of the first transparent electrode 120-1 to the fourth transparent electrode 120-4, the liquid crystal molecules in the liquid crystal layer 150 are aligned so as to be twisted 90 degrees along the c-axis direction as they move from the first substrate 110-1 to the second substrate 110-2. Further, the polarization plane (the direction of the polarization axis or the polarization component) of the light passing through the liquid crystal layer 150 is rotated 90 degrees according to the alignment directions of the liquid crystal molecules. That is, the light passing through the liquid crystal layer 150 (more specifically, the polarization component of the light passing through the liquid crystal layer 150) has optical rotation.

On the other hand, when voltages are applied so that a potential difference is generated between two adjacent transparent electrodes 120, an electric field (hereinafter referred to as a “lateral electric field”) is generated between the two adjacent transparent electrodes 120, and the alignment state of the liquid crystal molecules changes. As shown in FIG. 4B, the liquid crystal molecules in the liquid crystal layer 150 are aligned so as to be twisted 90 degrees along the c-axis direction from the first substrate 110-1 to the second substrate 110-2, while the liquid crystal molecules closer to the first substrate 110-1 are aligned in a convex arc shape with respect to the first substrate 110-1 by the lateral electric field between the first transparent electrode 120-1 and the second transparent electrode 120-2, and the liquid crystal molecules closer to the second substrate 110-2 are aligned in a convex arc shape with respect to the second substrate 110-2 by the lateral electric field between the third transparent electrode 120-3 and the fourth transparent electrode 120-4. The liquid crystal molecules aligned in the convex arc shape have a refractive index distribution, and the polarization component of light along the alignment direction of the liquid crystal molecules is diffused. In addition, since the cell gap d, which is the distance between the first substrate 110-1 and the second substrate 110-2, is sufficiently larger than the distance between two adjacent transparent electrodes (for example, 10 μm≤d≤30 μm, preferably 10 μm≤d≤30 μm, and more preferably 15 μm≤d≤25 μm), the electric field formed between the transparent electrodes 120 does not have much effect on the liquid crystal molecules located in the vicinity of the center between the first substrate 110-1 and the second substrate 110-2.

The light emitted from the light source 20 includes a polarization component in the x-axis direction (hereinafter, referred to as a “P-polarization component”) and a polarization component in the y-axis direction (hereinafter, referred to as an “S polarization component”). However, in the following description, the light is described as being divided into a first light 1000-1 having the P-polarization component and a second light 1000-2 having the S-polarization component, based on the polarization component of the light incident on the liquid crystal cell 100, for convenience.

Since the polarization direction of the P-polarized component of the first light 1000-1 incident on the first substrate 110-1 is different from the alignment direction of the liquid crystal molecules on the side of the first substrate 110-1, the first light 1000-1 is not diffused (see (1) in FIG. 4B). Further, the first light 1000-1 is rotated while passing through the liquid crystal layer 150, and the polarization component changes from the P-polarization component to the S-polarization component. Since the polarization direction of the S-polarization component of the first light 1000-1 is different from the alignment direction of the liquid crystal molecules on the side of the second substrate 110-2, the first light 1000-1 is not diffused (see (2) in FIG. 4B).

Since the polarization direction of the S-polarization component of the second light 1000-2 incident on the first substrate 110-1 is the same as the alignment direction of the liquid crystal molecules on the side of the first substrate 110-1, the second light 1000-2 is diffused in the y-axis direction in accordance with the refractive index distribution of the liquid crystal molecules (see (3) in FIG. 4B). Further, the second light 1000-2 is rotated while passing through the liquid crystal layer 150, and the polarization component changes from the S-polarization component to the P-polarization component. Since the polarization direction of the P-polarization component of the second light 1000-2 is the same as the alignment direction of the liquid crystal molecules on the side of the second substrate 110-2, the second light 1000-2 is diffused in the x-axis direction in accordance with the refractive index distribution of the liquid crystal molecules (see (4) in FIG. 4B).

Although the configuration of one liquid crystal cell 100 is described, in the optical element 10 including four liquid crystal cells 100, the P-polarization component of the light incident on the optical element 10 is controlled by the second liquid crystal cell 100-2 and the third liquid crystal cell 100-3, and the S-polarization component of the light incident on the optical element 10 is controlled by the first liquid crystal cell 100-1 and the fourth liquid crystal cell 100-4.

### 3. Configuration of Control Device 30

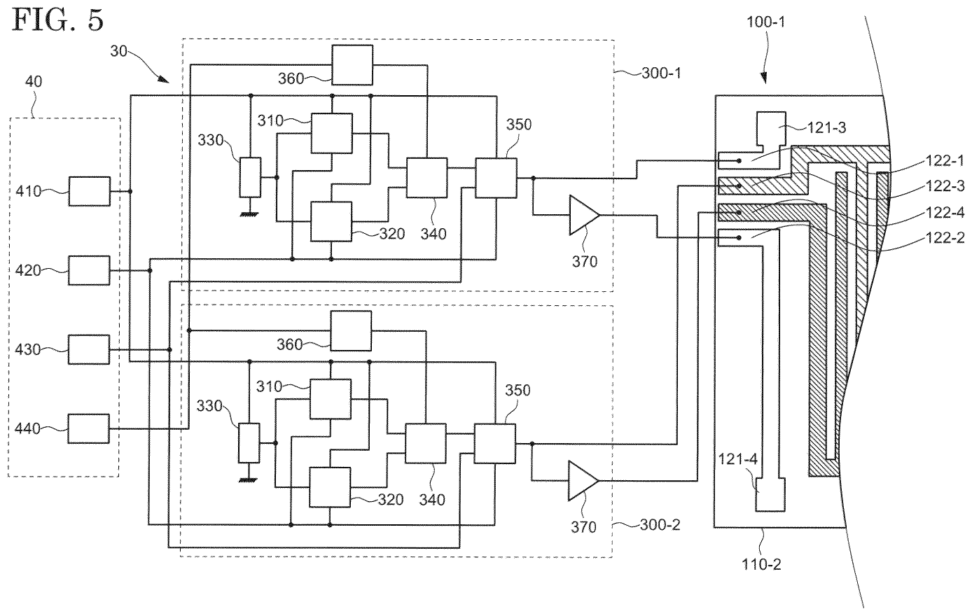

FIG. 5 is a block diagram showing a configuration of the illumination device 1 according to an embodiment of the present invention. FIG. 5 shows the control device 30, the power supply device 40 connected to the control device 30, and a part of the optical element 10 (specifically, the second substrate 110-2 of the first liquid crystal cell 100-1).

The control device 30 includes two control circuits 300 (a first control circuit 300-1 and a second control circuit 300-2) that control the first liquid crystal cell 100-1. The first control circuit 300-1 and the second control circuit 300-2 have the same circuit configuration. On the other hand, two signals output from the first control circuit 300-1 are input to the first terminal 122-1 and the second terminal 122-2 on the second substrate 110-2 of the first liquid crystal cell 100-1, and two signals output from the second control circuit 300-2 are input to the third terminal 122-3 and the fourth terminal 122-4 on the second substrate 110-2 of the first liquid crystal cell 100-1. As described above, the first terminal 122-1 and the second terminal 122-2 are connected to the first transparent electrode 120-1 and the second transparent electrode 120-2, respectively, on the first substrate 110-1. Further, the third terminal 122-3 and the fourth terminal 122-4 are connected to the third transparent electrode 120-3 and the fourth transparent electrode 120-4, respectively, on the second substrate 110-2. Therefore, a lateral electric field can be generated between the first transparent electrode 120-1 and the second transparent electrode 120-2 by the two signals output from the first control circuit 300-1, and the alignment state of the liquid crystal molecules on the first substrate 110-1 side can be changed by the lateral electric field. Similarly, a transverse electric field can be generated between the third transparent electrode 120-3 and the fourth transparent electrode 120-4 by the two signals output from the second control circuit 300-2, and the alignment state of the liquid crystal molecules on the second substrate 110-2 side can be changed by the lateral electric field. That is, the first liquid crystal cell 100-1 can be controlled by the first control circuit 300-1 and the second control circuit 300-2 included in the control device 30.

Although FIG. 5 shows only the first control circuit 300-1 and the second control circuit 300-2 that control the first liquid crystal cell 100-1, the second liquid crystal cell 100-2 to the fourth liquid crystal cell 100-4 are controlled in a similar manner. Thus, the control device 30 includes eight control circuits 300. However, the control device 30 may also include four control circuits 300. As described above, the P-polarization component of the light incident on the optical element 10 is controlled by the second liquid crystal cell 100-2 and the third liquid crystal cell 100-3, and the S-polarization component of the light incident on the optical element 10 is controlled by the first liquid crystal cell 100-1 and the fourth liquid crystal cell 100-4. Therefore, the control device 30 may be configured to include the first control circuit 300-1 and the second control circuit 300-2 that commonly control the first liquid crystal cell 100-1 and the fourth liquid crystal cell 100-4, and the first control circuit 300-1 and the second control circuit 300-2 that commonly control the second liquid crystal cell 100-2 and the third liquid crystal cell 100-3.

The control circuit 300 includes a non-inverting circuit 310, an inverting circuit 320, a variable resistor 330, a multiplexer 340, an adding circuit 350, a pulse generating circuit 360, and an inverter 370. The volume knob 31 (see FIG. 1) is connected to the variable resistor 330. When a user rotates the volume knob 31, the resistance of the variable resistor 330 changes.

Each of the non-inverting circuit 310 and the inverting circuit 320 has an input side connected to the variable resistor 330 and an output side electrically connected to the multiplexer 340. The non-inverting circuit 310 and the inverting circuit 320 output a first potential (+a V) whose amplitude a (where a is 0 or a positive number) is adjusted by the variable resistor 330 and a second potential (−a V) whose sign is the opposite to that of the first potential, respectively. The first potential (+a V) and the second potential (−a V) output from the non-inverting circuit 310 and the inverting circuit 320 are input to the multiplexer 340.

The multiplexer 340 is electrically connected to the adding circuit 350 and the pulse generating circuit 360. The output terminal of the multiplexer 340 is electrically connected to either the non-inverting circuit 310 or the inverter circuit 320 in accordance with the clock pulse signal generated by the pulse generating circuit 360, and as a result, the multiplexer 340 outputs one of the first potential (+a V) and the second potential (−a V). Therefore, the multiplexer 340 outputs a first pulse signal in which the first potential (+a V) and the second potential (−a V) are alternately repeated. The first pulse signal output from the multiplexer 340 is input to the adding circuit 350.

The adding circuit 350 is electrically connected to the inverter 370. Not only the first pulse signal but also a predetermined potential (hereinafter, referred to as a “center potential”) generated by a third power supply 430 described later, are input to the adding circuit 350. The adding circuit 350 adds the center potential to the potential of the first pulse signal. Therefore, the adding circuit 350 outputs a second pulse signal in which the center potential is added to the potential of the first pulse signal. More specifically, when the center potential is b V, the second pulse signal becomes a pulse signal having an amplitude of ±a V ((b+a) V and (b−a) V) centered on b V.

The control circuit 300 outputs the second pulse signal and a third pulse signal in which the phase of the second pulse signal is inverted by the inverter 370. More specifically, the third pulse signal is (b−a) V during a period in which the second pulse signal is (b+a) V, and the third pulse signal is (b+a) V during a period in which the second pulse signal is (b−a) V. The second pulse signal and the third pulse signal are input to the liquid crystal cell 100 so as to apply a potential to each of the two adjacent transparent electrodes 120 provided on the substrate 110 of the liquid crystal cell 100. Specifically, the second pulse signal and the third pulse signal output from the first control circuit 300-1 are input to the first liquid crystal cell 100-1 so as to apply potentials to the first transparent electrode 120-1 and the second transparent electrode 120-2, respectively provided on the first substrate 110-1. The second pulse signal and the third pulse signal output from the second control circuit 300-2 are input to the first liquid crystal cell 100-1 so as to apply potentials to the third transparent electrode 120-3 and the fourth transparent electrode 120-4, respectively, provided on the second substrate 110-2. As a result, the alignment state of the liquid crystal molecules on the first substrate 110-1 side of the first liquid crystal cell 100-1 is controlled by the second pulse signal, and the alignment state of the liquid crystal molecules on the second substrate 110-2 side of the first liquid crystal cell 100-1 is controlled by the third pulse signal. The same configuration is applied for the second liquid crystal cell 100-2 to the fourth liquid crystal cell 100-4.

The power supply device 40 includes a plurality of power supplies (a first power supply 410, a second power supply 420, a third power supply 430, and a fourth power supply 440) that generate power supply potentials. The first power supply 410 and the second power supply 420 generate a high potential (for example, +15 V) and a low potential (for example, −7.5 V) that are supplied to the control circuit 300, respectively. Specifically, the first power supply 410 and the second power supply 420 are electrically connected to the non-inverting circuit 310, the inverting circuit 320, and the adding circuit 350, and the high potential and the low potential are supplied to operate the non-inverting circuit 310, the inverting circuit 320, and the adding circuit 350. The third power supply 430 generates a center potential that is input to the adding circuit 350. The fourth power supply 440 generates a potential for operating the pulse generating circuit 360 of the control circuit 300.

FIG. 5 shows a configuration in which one power supply device 40 is connected to two control circuits 300 (a first control circuit 300-1 and a second control circuit 300-2) that control the first liquid crystal cell 100-1, and the single power supply device 40 is also connected to control circuits 300 that control the second liquid crystal cell 100-2 to the fourth liquid crystal cell 100-4.

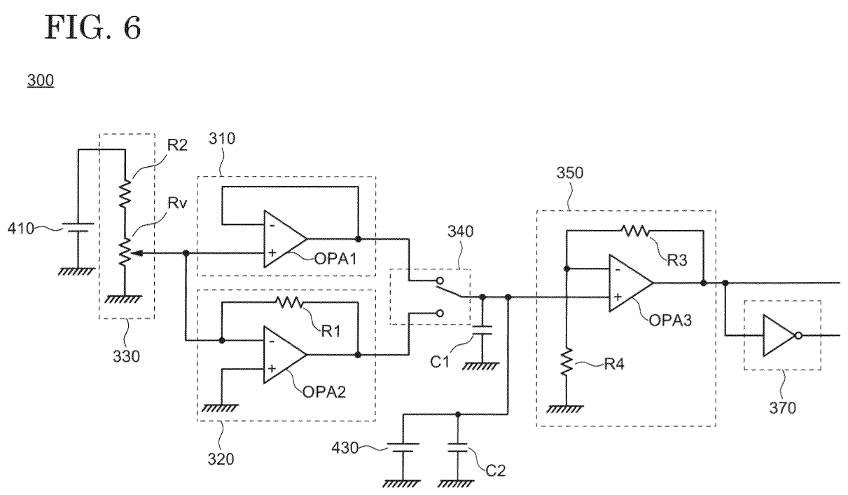

Although the circuit configuration of the control circuit 300 is described with reference to FIG. 6, the non-inverting circuit 310, the inverting circuit 320, and the adding circuit 350 are mainly described in the following description. Since a circuit configuration using an operational amplifier is applied for the control circuit 300, expensive components such as a DAC or a microcomputer are not required. Therefore, the manufacturing cost of the illumination device 1 can be reduced.

FIG. 6 is a circuit diagram showing a circuit configuration of the control circuit 300 of the illumination device 1 according to an embodiment of the present invention. In addition, FIG. 6 is an example of the circuit configuration of the control circuit 300, and the circuit configuration of the control circuit 300 is not limited thereto. Further, the power supply connection and the pulse generating circuit 360 that can be understood by a person skilled in the art are omitted in FIG. 6.

The non-inverting circuit 310 includes a first operational amplifier OPA1. In the first operational amplifier OPA1, an inverting input terminal (−) is connected to an output terminal. Further, a non-inverting input terminal (+) is connected to the variable resistor 330. With this circuit configuration, the first operational amplifier OPA1 operates so that a potential input to the inverting input terminal (−) is equal to a potential (+a V) input to the non-inverting input terminal (+) and adjusted by the variable resistor 330, and a first potential (+a V) is output from the output terminal.

The inverting circuit 320 includes a second operational amplifier OPA2. In the second operational amplifier OPA2, an inverting input terminal (−) is connected to an output terminal via a resistive element R1. The resistive element R1 functions as a feedback resistor. The inverting input terminal (−) is connected to a variable resistor 330. The non-inverting input terminal (+) is connected to GND. With this circuit configuration, the second operational amplifier OPA2 operates so that the potential input to the inverting input terminal (−) is equal to the GND potential input to the non-inverting input terminal (+), and a second potential (−a V) having the opposite sign to the potential (+a V) adjusted by the variable resistor 330 is output from the output terminal.

The variable resistor 330 includes, for example, a resistive element R2 and a variable resistive element Rv. The resistive element R2 is connected in series with the variable resistive element Rv. The resistive element R2 functions as a fixed resistor that determines the range of the potential output through the variable resistor 330. For example, when the potential generated by the first power supply 410 is +15 V, the range of the potential output through the variable resistive element Rv (for example, 0 to +3 V (a=0 to 3), 0 to +5 V (a=0 to 5), 0 to +7.5 V (a=0 to 7.5), 0 to +10 V (a=0 to 10), or 0 to +15 V (a=0 to 15), etc.) can be adjusted by connecting the resistive element R2 to the variable resistive element Rv.

The first potential (+a V) output from the non-inverting circuit 310 and the second potential (−a V) output from the inverting circuit 320 are input to the multiplexer 340. As described above, the multiplexer 340 alternately selects the first potential (+a V) and the second potential (−a V), and outputs a first pulse signal in which the first potential (+a V) and the second potential (−a V) are alternately repeated.

The adding circuit 350 includes a third operational amplifier OPA3. In the third operational amplifier OPA3, the inverting input terminal (−) is connected to the output terminal via a resistive element R3. The resistive element R3 functions as a feedback resistor. The inverting input terminal (−) is connected to GND via a resistive element R4. The resistive element R4 functions as a bias compensation resistor. On the other hand, the non-inverting input terminal (+) is connected to the multiplexer 340 and the third power supply 430. With this circuit configuration, the third operational amplifier OPA3 operates so that the potential input to the inverting input terminal (−) is equal to the potential obtained by adding the center potential generated by the third power supply 430 to the potential of the first pulse signal, and a second pulse signal obtained by adding the center potential to the potential of the first pulse signal is output from the output terminal. Although the center potential may be any potential, it is preferable that the center potential is equal to the maximum potential (a V) of the potential output via the variable resistive element Rv (a=b). More specifically, when the maximum value of the potential is 3 V, a configuration can be applied in which the center potential is 3 V (a=b=3). Similarly, a configuration can be applied in which a=b=5, a=b=7.5, a=b=10, or a=b=15.

A capacitive element C1, one end of which is connected to GND, is electrically connected to a signal line of a first pulse signal input to the non-inverting input terminal of the third operational amplifier OPA3. A capacitive element C2, one end of which is connected to GND, is electrically connected to a potential line of a center potential input to the non-inverting input terminal of the third operational amplifier OPA3. The capacitive element C1 is charged with the potential of the first pulse signal, and the capacitive element C2 is charged with the center potential, so that the potential obtained by adding the center potential to the potential of the first pulse signal can be stabilized.

The second pulse signal output from the adding circuit 350 has its phase inverted by the inverter 370. As a result, the control circuit 300 outputs the second pulse signal and the third pulse signal obtained by inverting the phase of the second pulse signal.

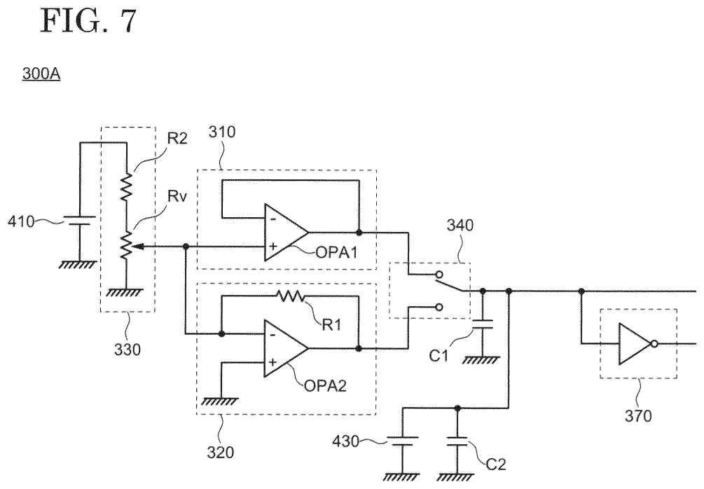

FIG. 7 is a circuit diagram showing a circuit configuration of a control circuit 300 A of the illumination device 1 according to an embodiment of the present invention. In the present embodiment, a configuration in which the adding circuit 350 is not provided in the control circuit as shown in FIG. 7 can be applied. In this case, the control circuit 300A outputs the first pulse signal and a fourth pulse signal obtained by inverting the phase of the first pulse signal.

As described in the above description, the illumination device 1 according to the present embodiment can control the optical element 10 and control the light distribution shape and light distribution angle of the light emitted from the light source 20 without including a DAC or a microcomputer. Therefore, the illumination device 1 can reduce manufacturing costs.

### Second Embodiment

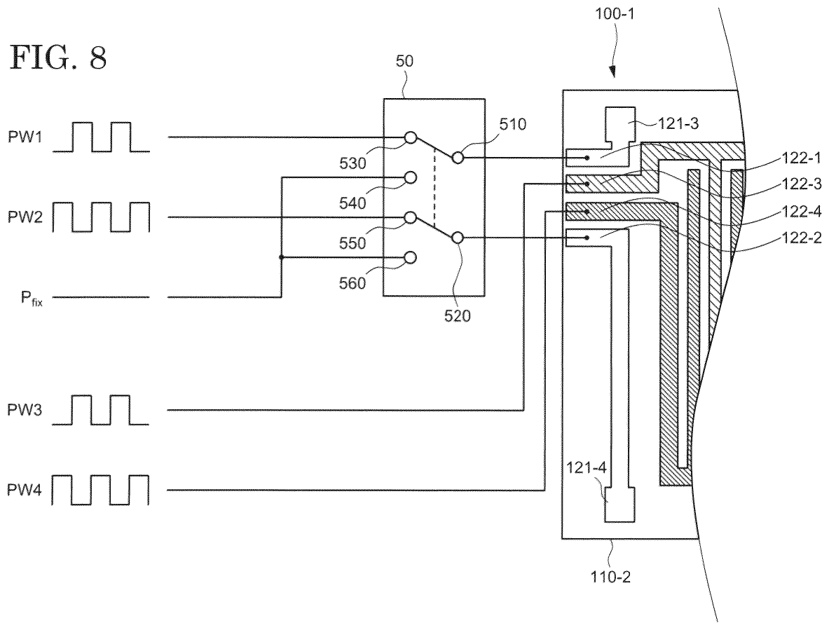

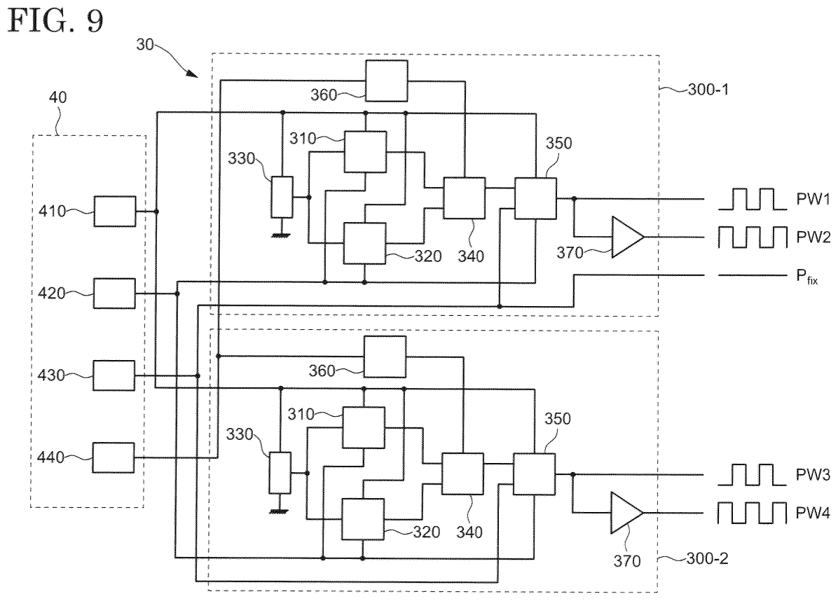

An illumination device 2 according to an embodiment of the present invention is described with reference to FIGS. 8 and 9. In the illumination device 2, the light distribution shape can be changed using a switch. In the following description, when a configuration of the illumination device 2 is the same as that of the illumination device 1, the description of the configuration of the illumination device 2 may be omitted.

FIG. 8 is a block diagram showing a configuration of the illumination device 2 according to an embodiment of the present invention. The illumination device 2 further includes a switch 50 shown in FIG. 8 in addition to the optical element 10, the light source 20, the control device 30, and the power supply device 40 shown in FIG. 1.

The switch 50 includes a plurality of contacts (a first contact 510, a second contact 520, a third contact 530, a fourth contact 540, a fifth contact 550, and a sixth contact 560). In the switch 50, the first contact 510 is electrically connected to one of the third contact 530 and the fourth contact 540, and the second contact 520 is electrically connected to one of the fifth contact 550 and the sixth contact 560. The connection of the first contact 510 and the connection of the second contact 520 in the switch 50 are interlocked. When the first contact 510 is electrically connected to the third contact 530, the second contact 520 is electrically connected to the fifth contact 550. On the other hand, when the first contact 510 is electrically connected to the fourth contact 540, the second contact 520 is electrically connected to the sixth contact 560.

Although the switch 50 may be, for example, a slide switch, a push switch (alternate switch), or a toggle switch, the switch 50 is not limited thereto. The switch 50 may have a configuration in which the connection of the contacts can be switched. For example, when the switch 50 is a push switch, the connection of the first contact 510 is switched from the third contact 530 to the fourth contact 540 by pushing the button. When the button is pushed again, the connection of the first contact 510 is switched from the fourth contact 540 to the third contact 530.

The switch 50 shown in FIG. 8 is disposed between the control device 30 and the first liquid crystal cell 100-1. The first contact 510 is electrically connected to the first terminal 122-1. The second contact 520 is electrically connected to the second terminal 122-2. The first pulse wave PW1 and the second pulse wave PW2 are input to the third contact 530 and the fifth contact 550, respectively. Further, the fixed potential P_{fix} is input to the fourth contact 540 and the sixth contact 560. The first pulse wave PW1 and the second pulse wave PW2 are inverted in phase. The fixed potential P_{fix} is any potential within the range of the amplitude of the first pulse wave PW1 or the second pulse wave PW2. Furthermore, the third terminal 122-3 and the fourth terminal 122-4 are input to the third pulse wave PW3 and the fourth pulse wave PW4, respectively. The third pulse wave PW3 is the same as the first pulse wave PW1, and the fourth pulse wave PW4 is the same as the second pulse wave PW2.

When the first contact 510 and the second contact 520 are electrically connected to the third contact 530 and the fifth contact 550, respectively, the first pulse wave PW1, the second pulse wave PW2, the third pulse wave PW3, and the fourth pulse wave PW4 are input to the first terminal 122-1, the second terminal 122-2, the third terminal 122-3, and the fourth terminal 122-4, respectively. In this case, lateral electric fields are generated between the first transparent electrode 120-1 and the second transparent electrode 120-2 on the first substrate 110-1 of the first liquid crystal cell 100-1, and between the third transparent electrode 120-3 and the fourth transparent electrode 120-4 on the second substrate 110-2. Therefore, the light passing through the first liquid crystal cell 100-1 is isotropically diffused on the first substrate 110-1 side and the second substrate 110-2 side, and has a circular shape as a light distribution.

When the contacts are switched by the switch 50, the first contact 510 and the second contact 520 are electrically connected to the fourth contact 540 and the sixth contact 560, respectively. Therefore, the fixed potential P_{fix} is input to the first terminal 122-1 and the second terminal 122-2, and the third pulse wave PW3 and the fourth pulse wave PW4 are input to the third terminal 122-3 and the fourth terminal 122-4, respectively. In this case, although a lateral electric field is not generated between the first transparent electrode 120-1 and the second transparent electrode 120-2 on the first substrate 110-1 of the first liquid crystal cell 100-1, a lateral electric field is generated between the third transparent electrode 120-3 and the fourth transparent electrode 120-4 on the second substrate 110-2. Therefore, the light passing through the first liquid crystal cell 100-1 is anisotropically diffused only on the second substrate side, and has a linear shape extending in one direction as a light distribution.

In the above description, although the configuration in which the switch 50 is connected to the first liquid crystal cell 100-1 is described for convenience, it is preferable that the switches 50 are also connected to the second liquid crystal cell 100-2 to the fourth liquid crystal cell 100-4. In this case, each of the four switches 50 may be connected to the first liquid crystal cell 100-1 to the fourth liquid crystal cell 100-4, and the multiple contacts of one switch 50 may be electrically connected to the first terminal 122-1 to the fourth terminal 122-4, respectively, of each of the first liquid crystal cell 100-1 to the fourth liquid crystal cell. In addition, although details are omitted, the connection between the terminals (the first terminal 122-1 to the fourth terminal 122-4) of each liquid crystal cell 100 and the switch 50 may change depending on the light distribution shape. In the illumination device 2, various light distribution shapes can be formed by using the switch 50.

FIG. 9 is a block diagram showing a configuration for generating a pulse wave and a fixed potential in the illumination device 2 according to an embodiment of the present invention. The pulse wave and the fixed potential input to the contacts of the switch 50 are generated using the control device 30 and the power supply device 40.

As described in the First Embodiment, the first control circuit 300-1 outputs the second pulse signal and the third pulse signal in which the phase of the second pulse signal is inverted. Here, the first pulse wave PW1 and the second pulse wave PW2 correspond to the second signal and the third signal generated by the first control circuit 300-1, respectively. That is, the first pulse wave PW1 and the second pulse wave PW2 are generated by the first control circuit 300-1. Further, the second control circuit 300-2 outputs the second pulse signal and the third pulse signal in which the phase of the second pulse signal is inverted. The second signal and the third signal generated by the second control circuit 300-2 correspond to the third pulse wave PW3 and the fourth pulse wave PW4, respectively. That is, the second control circuit 300-2 generates the third pulse wave PW3 and the fourth pulse wave PW4. On the other hand, the fixed potential P_{fix} is generated by the third power supply 430. That is, the fixed potential P_{fix} is equal to the center potential.

In this way, a pulse wave and a fixed potential can be generated without significantly changing the configurations of the control device 30 and the power supply device 40 in the illumination device 2.

As described in the above description, the illumination device 2 according to the present embodiment can switch the light distribution shape of the light emitted from the light source 20 and control the light distribution angle using the switch 50 without including a DAC or a microcomputer. Therefore, the illumination device 2 can reduce manufacturing costs.

Within the scope of the present invention, those skilled in the art may conceive of examples of changes and modifications, and it is understood that these examples of changes and modifications are also included within the scope of the present invention. For example, additions, deletions, or design changes of constituent elements, or additions, omissions, or changes to conditions of steps as appropriate based on the respective embodiments described above are also included within the scope of the present invention as long as the gist of the present invention is provided.

Further, other effects which differ from those brought about by each embodiment, but which are apparent from the description herein or which can be readily predicted by those skilled in the art, are naturally understood to be brought about by the present invention.

What is claimed is:

1. An illumination device, comprising:
a light source;
an optical element comprising a first liquid crystal cell and a second liquid crystal cell, and transmitting light emitted from the light source in a diffusible manner; and
a control device connected to the optical element, and controlling the optical element,
wherein each of the first liquid crystal cell and the second liquid crystal cell comprises:
a first substrate on which a first transparent electrode and a second transparent electrode are arranged each extending in a first direction,
a second substrate on which a third transparent electrode and a fourth transparent electrode are arranged each extending in a second direction orthogonal to the first direction, and
a liquid crystal layer between the first substrate and the second substrate,
wherein the control device comprises:
a first non-inverting circuit outputting a first potential,
a first inverting circuit outputting a second potential having an opposite sign to the first potential,
a first multiplexer connected to the first non-inverting circuit and the first inverting circuit, and outputting a first pulse signal in which the first potential and the second potential are alternately repeated, and
a first inverter connected to the first multiplexer, and outputting a second pulse signal having an inverted phase of the first pulse signal,
wherein the first pulse signal is input to the first transparent electrode of the first liquid crystal, and
wherein the second pulse signal is input to the second transparent electrode of the first liquid crystal cell.

2. The illumination device according to claim 1,
wherein the first liquid crystal cell and the second liquid crystal cell are arranged such that the second substrate of the first liquid crystal cell and the second substrate of the second liquid crystal cell face each other,
wherein the first pulse signal is further input to the first transparent electrode of the second liquid crystal cell, and
wherein the second pulse signal is further input to the second transparent electrode of the second liquid crystal cell.

3. The illumination device according to claim 1,
wherein the control device further comprises:
a second non-inverting circuit outputting a third potential,
a second inverting circuit outputting a fourth potential having an opposite sign to the third potential,
a second multiplexer connected to the second non-inverting circuit and the second inverting circuit, and outputting a third pulse signal in which the third potential and the fourth potential are alternately repeated, and
a second inverter connected to the second multiplexer, and outputting a fourth pulse signal having an inverted phase of the third pulse signal,
wherein the third pulse signal is input to the third transparent electrode of the first liquid crystal, and
wherein the fourth pulse signal is input to the fourth transparent electrode of the first liquid crystal cell.

4. The illumination device according to claim 3,
wherein the control device further comprises:
a first variable resistor connected to the first non-inverting circuit and the first inverting circuit, and configured to adjust an amplitude of the first potential, and
a second variable resistor connected to the second non-inverting circuit and the second inverting circuit, and configured to adjust an amplitude of the third potential,
wherein each of the first non-inverting circuit, the first inverting circuit, the second non-inverting circuit, and the second inverting circuit comprises an operational amplifier,
wherein the first variable resistor is connected to a non-inverting input terminal of the operational amplifier of the first non-inverting circuit and an inverting input terminal of the operational amplifier of the first inverting circuit, and
wherein the second variable resistor is connected to a non-inverting input terminal of the operational amplifier of the second non-inverting circuit and an inverting input terminal of the operational amplifier of the second inverting circuit.

5. The illumination device according to claim 3,
wherein the first liquid crystal cell and the second liquid crystal cell are arranged such that the second substrate of the first liquid crystal cell and the second substrate of the second liquid crystal cell face each other,
wherein the first pulse signal is further input to the first transparent electrode of the second liquid crystal cell,
wherein the second pulse signal is further input to the second transparent electrode of the second liquid crystal cell,
wherein the third pulse signal is further input to the third transparent electrode of the second liquid crystal cell, and
wherein the fourth pulse signal is further input to the fourth transparent electrode of the second liquid crystal cell.

6. The illumination device according to claim 5,
wherein the control device further comprises:
a first variable resistor connected to the first non-inverting circuit and the first inverting circuit, and configured to adjust an amplitude of the first potential, and
a second variable resistor connected to the second non-inverting circuit and the second inverting circuit, and configured to adjust an amplitude of the third potential,
wherein each of the first non-inverting circuit, the first inverting circuit, the second non-inverting circuit, and the second inverting circuit comprises an operational amplifier,
wherein the first variable resistor is connected to a non-inverting input terminal of the operational amplifier of the first non-inverting circuit and an inverting input terminal of the operational amplifier of the first inverting circuit, and
wherein the second variable resistor is connected to a non-inverting input terminal of the operational amplifier of the second non-inverting circuit and an inverting input terminal of the operational amplifier of the second inverting circuit.

7. The illumination device according to claim 1, further comprising a switch connected to the first liquid crystal cell and the control device,
wherein the switch comprises:
a first contact electrically connected to the first transparent electrode,
a second contact electrically connected to the second transparent electrode,
a third contact to which the first pulse signal is input,
a fourth contact to which a fixed potential is input,
a fifth contact to which the second pulse signal is input, and
a sixth contact to which the fixed potential is input, and
wherein by switching the switch, the first contact is electrically connected to one of the third contact and the fourth contact, and the second contact is electrically connected to one of the fifth contact and the sixth contact.

8. The illumination device according to claim 1,
wherein the control device further comprises a first variable resistor connected to the first non-inverting circuit and the first inverting circuit, and configured to adjust an amplitude of the first potential,
wherein each of the first non-inverting circuit and the first inverting circuit comprises an operational amplifier, and
wherein the first variable resistor is connected to a non-inverting input terminal of the operational amplifier of the first non-inverting circuit and an inverting input terminal of the operational amplifier of the first inverting circuit.

9. An illumination device, comprising:
a light source;
an optical element comprising a first liquid crystal cell and a second liquid crystal cell, and transmitting light emitted from the light source in a diffusible manner; and
a control device connected to the optical element, and controlling the optical element,
wherein each of the first liquid crystal cell and the second liquid crystal cell comprises:
a first substrate on which a first transparent electrode and a second transparent electrode are arranged each extending in a first direction,
a second substrate on which a third transparent electrode and a fourth transparent electrode are arranged each extending in a second direction orthogonal to the first direction, and
a liquid crystal layer between the first substrate and the second substrate,
wherein the control device comprises:
a first non-inverting circuit outputting a first potential,
a first inverting circuit outputting a second potential having an opposite sign to the first potential,
a first multiplexer connected to the first non-inverting circuit and the first inverting circuit, and outputting a first pulse signal in which the first potential and the second potential are alternately repeated, and
a first adding circuit connected to the first multiplexer, and outputting a second pulse signal in which a predetermined potential is added to a potential of the first pulse signal, and
a first inverter connected to the first adding circuit, and outputting a third pulse signal having an inverted phase of the second pulse signal,
wherein the second pulse signal is input to the first transparent electrode of the first liquid crystal, and
wherein the third pulse signal is input to the second transparent electrode of the first liquid crystal cell.

10. The illumination device according to claim 9,
wherein the first liquid crystal cell and the second liquid crystal cell are arranged such that the second substrate of the first liquid crystal cell and the second substrate of the second liquid crystal cell face each other,
wherein the second pulse signal is further input to the first transparent electrode of the second liquid crystal cell, and
wherein the third pulse signal is further input to the second transparent electrode of the second liquid crystal cell.

11. The illumination device according to claim 9,
wherein the control device further comprises:
a second non-inverting circuit outputting a third potential,
a second inverting circuit outputting a fourth potential having an opposite sign to the third potential,
a second multiplexer connected to the second non-inverting circuit and the second inverting circuit, and outputting a fourth pulse signal in which the third potential and the fourth potential are alternately repeated,
a second adding circuit connected to the second multiplexer, and outputting a fifth pulse signal in which a predetermined potential is added to a potential of the fourth pulse signal, and
a second inverter connected to the second adding circuit, and outputting a sixth pulse signal having an inverted phase of the fifth pulse signal,
wherein the fifth pulse signal is input to the third transparent electrode of the first liquid crystal, and
wherein the sixth pulse signal is input to the fourth transparent electrode of the first liquid crystal cell.

12. The illumination device according to claim 11,
wherein the control device further comprises:
a first variable resistor connected to the first non-inverting circuit and the first inverting circuit, and configured to adjust an amplitude of the first potential, and
a second variable resistor connected to the second non-inverting circuit and the second inverting circuit, and configured to adjust an amplitude of the third potential,
wherein each of the first non-inverting circuit, the first inverting circuit, the second non-inverting circuit, and the second inverting circuit comprises an operational amplifier,
wherein the first variable resistor is connected to a non-inverting input terminal of the operational amplifier of the first non-inverting circuit and an inverting input terminal of the operational amplifier of the first inverting circuit, and
wherein the second variable resistor is connected to a non-inverting input terminal of the operational amplifier of the second non-inverting circuit and an inverting input terminal of the operational amplifier of the second inverting circuit.

13. The illumination device according to claim 11,
wherein the first liquid crystal cell and the second liquid crystal cell are arranged such that the second substrate of the first liquid crystal cell and the second substrate of the second liquid crystal cell face each other,
wherein the second pulse signal is further input to the first transparent electrode of the second liquid crystal cell,
wherein the third pulse signal is further input to the second transparent electrode of the second liquid crystal cell,
wherein the fifth pulse signal is further input to the third transparent electrode of the second liquid crystal cell, and
wherein the sixth pulse signal is further input to the fourth transparent electrode of the second liquid crystal cell.

14. The illumination device according to claim 13,
wherein the control device further comprises:
a first variable resistor connected to the first non-inverting circuit and the first inverting circuit, and configured to adjust an amplitude of the first potential, and
a second variable resistor connected to the second non-inverting circuit and the second inverting circuit, and configured to adjust an amplitude of the third potential,
wherein each of the first non-inverting circuit, the first inverting circuit, the second non-inverting circuit, and the second inverting circuit comprises an operational amplifier,
wherein the first variable resistor is connected to a non-inverting input terminal of the operational amplifier of the first non-inverting circuit and an inverting input terminal of the operational amplifier of the first inverting circuit, and
wherein the second variable resistor is connected to a non-inverting input terminal of the operational amplifier of the second non-inverting circuit and an inverting input terminal of the operational amplifier of the second inverting circuit.

15. The illumination device according to claim 9, further comprising a switch connected to the first liquid crystal cell and the control device,
wherein the switch comprises:
a first contact electrically connected to the first transparent electrode,
a second contact electrically connected to the second transparent electrode,
a third contact to which the first pulse signal is input,
a fourth contact to which the predetermined potential is input,
a fifth contact to which the second pulse signal is input, and
a sixth contact to which the predetermined potential is input, and
wherein by switching the switch, the first contact is electrically connected to one of the third contact and the fourth contact, and the second contact is electrically connected to one of the fifth contact and the sixth contact.

16. The illumination device according to claim 9,
wherein the control device further comprises a first variable resistor connected to the first non-inverting circuit and the first inverting circuit, and configured to adjust an amplitude of the first potential,
wherein each of the first non-inverting circuit and the first inverting circuit comprises an operational amplifier, and
wherein the first variable resistor is connected to a non-inverting input terminal of the operational amplifier of the first non-inverting circuit and an inverting input terminal of the operational amplifier of the first inverting circuit.
